(19) United States
(12) Patent Application Publication
(10) Pub. No.: US 2008/0313788 A1
(43) Pub. Date: Dec. 25, 2008

(54) Gloves

(76) Inventor: Xipei Yan, Ningbo City (CN)

Correspondence Address: DAVID AND RAYMOND PATENT FIRM, 108 N. YNEZ AVE., SUITE 128, MONTEREY PARK, CA, 91754, US

(21) Appl. No.: 11/985,643

(22) Filed: Nov. 15, 2007

(30) Foreign Application Priority Data
Jun. 20, 2007 (CN) 200720110989.7

(51) Int. Cl. A41D 19/01; A41D 19/00; A47K 7/02; A01K 13/00

(52) U.S. Cl. 2/158; 2/159; 15/227; 119/611

(57) ABSTRACT

A glove includes a glove body having a palm portion and one or more finger portions, a grooming unit, and an adhering layer provided at the glove body to adhere the grooming unit thereto. The grooming unit includes a palm grooming member affixed to the palm portion, a finger grooming member affixed to each of the finger portions, and a plurality of combing teeth spacedly protruded from the palm grooming member and the finger grooming member. A plurality of first and second flexible bands are provided at the palm grooming member and the finger grooming member for enhancing the hand and finger movements of the user when the user wears the glove body.

### BACKGROUND OF THE PRESENT INVENTION

1. Field of Invention

The present invention relates to a cleansing tool, and more particular to gloves which is used for grooming the hair of human being or animal.

2. Description of Related Arts

The grooming gloves are gloves with comb teeth on the outside surface for hair grooming. Since it is convenient for the user to wear the gloves at his/her palms, the user is able to effectively perform the grooming operation. Although the current grooming glove can be worn, the grooming portion is only provided at the palm section of the glove. Chinese Pat No. 97201401.2 discloses a pets grooming glove comprising a primping brush provided at one side of the glove and a combing brush provided at another side of the glove. The primping brush is used for washing and cleansing the hairs of the pet while the combing brush is used for extracting tangles and snarls of the hairs of the pet. However, such glove has no support for the user's fingers. Therefore, the user cannot apply any brushing force at the fingers of the user. In addition, the brushes are formed in a one piece flat panel structure such that the brushes are not designed to fittingly brush on the shape of the pet body. Thus, placing two different types of brushes in one glove will highly increase the cost thereof and will make the structure too complex. Since there is no connection between the brushes and the fingers, the glove cannot be freely bent in responsive to the natural movement of the palm of the user.

### SUMMARY OF THE PRESENT INVENTION

A main object of the present invention is to provide a grooming glove which is convenient to use, low cost, flexible, and environment friendly.

In order to accomplish the above object, the present invention provides a glove comprising a glove body adapted for being worn by a user, a grooming unit, and an adhering layer affixing the grooming unit at the glove body.

The preferred embodiments of the present invention are:

The grooming unit comprises a palm grooming member affixed to the palm portion of the glove body and a finger grooming member affixed to at least one of the finger portions of the glove body.

The finger grooming member is integrally extended from the palm grooming member.

A first flexible band is extended between the finger grooming member and the palm grooming member.

The finger grooming member comprises a finger head member and a finger root member, wherein a second flexible band is extended from the finger head member to the finger root member.

Accordingly, the glove body contains two finger portions and a thumb portion, wherein the finger grooming member is provided at each of the finger portions of the glove body. In other words, four finger grooming members are respectively adhered to the four finger portions of the glove body.

The grooming unit comprises a plurality of combing teeth protruding from the glove body, wherein each of the combing teeth has a cone shape or a pillar shape.

Accordingly, the combing teeth are aligned in a row manner. At least a row of the combing teeth is misaligned with another neighboring row of the combing teeth. In other words, one orthonormal matrix of tooth row is diagonally arrayed relative to another orthonormal matrix of the neighboring tooth row of the combing teeth.

Comparing to the current technology, the glove of the present invention provides the grooming unit adhered to the contacting side of the glove body such that the combing teeth are spacedly protruded from the contacting side of glove body. The advantages of the invention are: the combing teeth are using current available technique to reduce the production cost and to enhance the practical use thereof; the grooming unit is constructed with multiple of members which are linked by the flexible bands to enhance the flexibility of the finger portions of the glove body in responsive to the finger movement of the user; the benzene-free adhering layer is strong, harmless, and environment friendly to secure the attachment between the grooming unit and the glove body.

These and other objectives, features, and advantages of the present invention will become apparent from the following detailed description, the accompanying drawings, and the appended claims.

### BRIEF DESCRIPTION OF THE DRAWINGS

FIG. 1 is the front view of the glove of a first embodiment of the present invention, illustrating the glove as a right handed glove.

FIG. 2 is the front view of the right hand glove of a second embodiment of the present invention.

FIG. 3 is the front view of the right hand glove of a third embodiment of the present invention.

FIG. 4 is the front view of the right hand glove of a fourth embodiment of the present invention.

FIG. 5 is the side view of the right hand glove of the second embodiment of the present invention.

FIG. 6 is the bottom view of the right hand glove of the second to fourth embodiments of the present invention.

FIG. 7 illustrates the grooming unit of the glove, illustrating the orthonormal matrix of tooth row.

FIG. 8 is the sectional view of the glove, illustrating the grooming unit being adhered on the glove body via an adhering layer.

### DETAILED DESCRIPTION OF THE PREFERRED EMBODIMENT

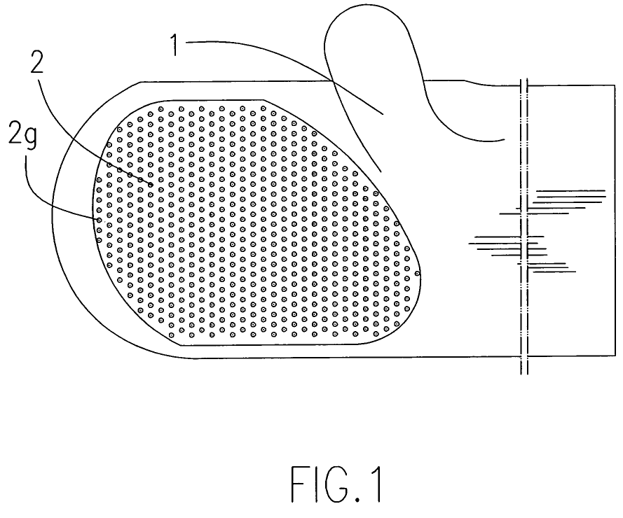

As shown in FIG. 1 of the drawings, a glove, which is embodied as a right handed glove, according to a first preferred embodiment of the present invention is illustrate, wherein the glove comprises a glove body 1 adapted for being worn by a user, having a contacting side, a grooming unit 2, and an adhering layer 3 affixing the grooming unit 2 at the contacting side of the glove body 1. The grooming unit 2 comprises a plurality of combing teeth 2g spacedly and evenly provided at the contacting side of the glove body 1. Accordingly, the glove body 1 has a palm portion and a finger portion, wherein when the user wears the glove body 1, the palm of the user receives in the palm portion and fingers of the user receive in the finger portion. The grooming unit 2 also has a one piece structure provided at the palm portion and finger portion of the glove body 1. The one piece structure of the glove body 1 is easy to fabricate. However, each of the finger movements of the user is limited within the finger portion of the glove body 1. It is worth to mention that the gloves of the present invention provide both left handed glove body and right handed glove body.

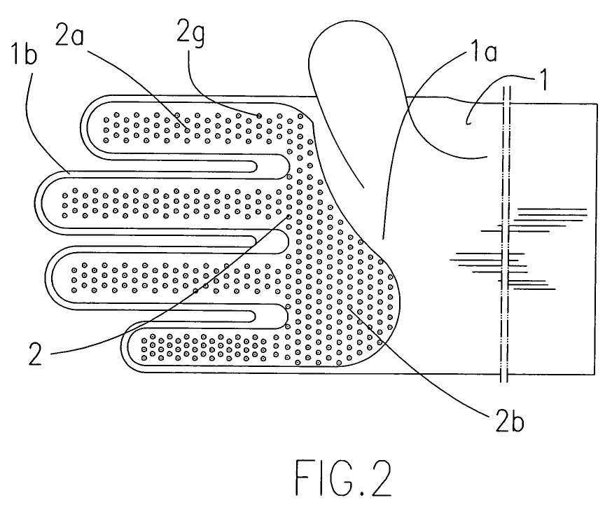

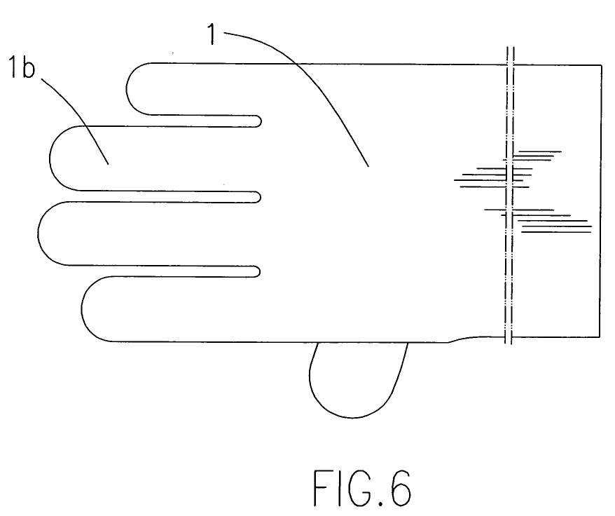

As shown in FIG. 2, a glove of a second embodiment illustrates an alternative mode of the first embodiment, wherein the grooming unit 2 comprises a palm grooming member 2b and a finger grooming member 2a. as shown in FIGS. 2 and 6, the glove body 1 has a palm portion 1a, four finger portions 1b extended from the palm portion 1a, and a thumb portion, wherein when the user wears the glove body 1, the palm of the user receives in the palm portion 1a, the fingers of the user receive in the finger portions 1b respectively, and the thumb of the user receives in the thumb portion. The palm grooming member 2b is provided at the palm portion 1a of the glove body 1. The finger grooming member 2a is provided at each of the finger portions 1b of the glove body 1. In other words, four finger grooming members 2a are adhered to the finger portions 1b of the glove body 1 while there is no grooming member 2a provided at the thumb portion of the glove body 1. Accordingly, the finger grooming members 2a are integrally extended from the palm grooming member 2b to form a one-piece structure of the grooming unit 2. Since there is not flexible connection between the finger grooming members 2a and the palm grooming member 2b, the grooming unit 2 may not provide enough flexibility in responsive to the hand movement of the user.

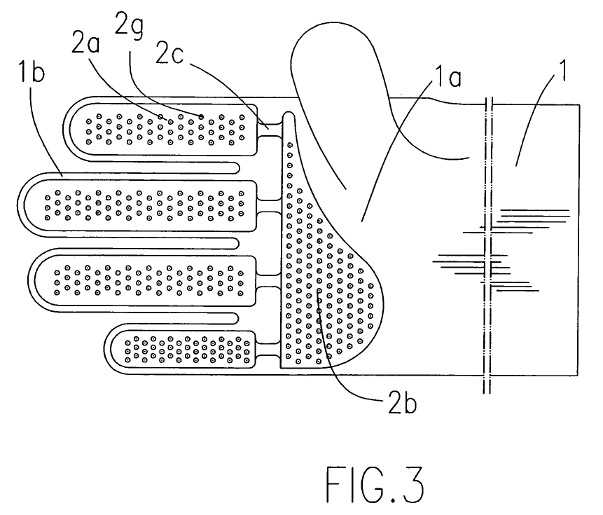

As shown in FIG. 3, a glove of a third embodiment illustrates an alternative mode of the second embodiment, wherein the glove body 1 has a palm portion 1a, four finger portions 1b extended from the palm portion 1a, and a thumb portion. Similar to the second embodiment, the grooming unit 2 also comprises a palm grooming member 2b provided at the palm portion 1a of the glove body 1 and a finger grooming member 2a provided at each of the finger portions 1b of the glove body 1. According to the third embodiment, the grooming unit 2 further comprises a plurality of first flexible bands 2c extended from the finger grooming members 2a to the palm grooming member 2b. In other words, there are four first flexible bands 2c extended from the finger grooming members 2a respectively to the palm grooming member 2b. Accordingly, each of the first flexible bands 2c is located at the connection between the palm portion 1a and the finger portion 1b of the glove body 1 in responsive to the joint of the user's hand between the finger and the palm thereof. In other words, each of the first flexible bands 2c is located between the proximal phalanges and the metacarpals of the user's hand. The first flexible band 2c enhances the flexibility of the grooming unit 2 in responsive to the hand movement of the user. It is worth to mention that each of the finger grooming members 2b is formed in a one piece structure, the grooming unit 2 may not provide enough flexibility in responsive to the finger movement of the user.

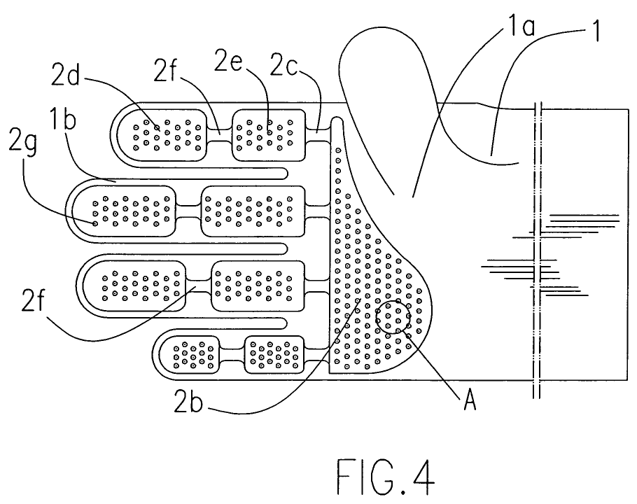

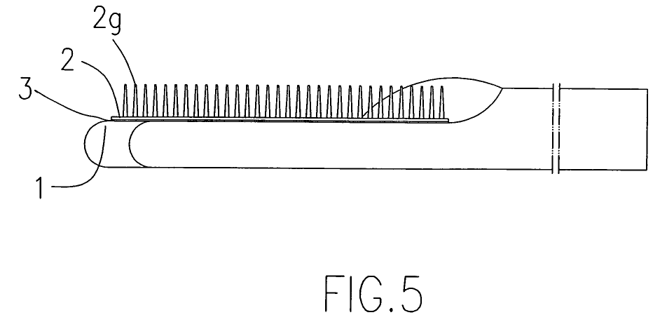

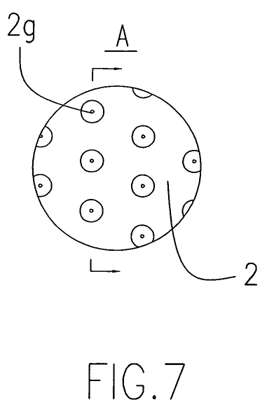

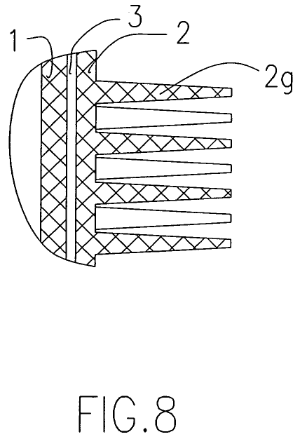

As shown in FIG. 4, a glove of a fourth embodiment illustrates an alternative mode of the third embodiment. Similar to the third embodiment, the glove body 1 has a palm portion 1a, four finger portions 1b, and a thumb portion. The grooming unit 2 comprises a palm grooming member 2b provided at the palm portion 1a of the glove body 1 and a finger grooming member 2a provided at each of the finger portions 1b of the glove body 1. There is not finger grooming member 2a provided at the thumb portion of the glove body 1. A plurality of first flexible bands 2c extended from the finger grooming members 2a to the palm grooming member 2b. According to the fourth embodiment, each of the finger grooming members 2a comprises a finger head member 2d and a finger root member 2e spacedly affixed to the respective finger portion 1b of the glove body 1, wherein a second flexible band 2f extended from the finger head member 2d to the finger root member 2e. In this fourth embodiment, each of the second flexible bands 2e is located between the proximal phalanges and intermediate phalanges of the user's hand. This design can further improve the flexibility of the grooming unit 2 in responsive to the finger movement of the user. In this preferred embodiment, the grooming unit 2 enhances the entire hand and finger movements of the user. Accordingly, the grooming unit 2 comprises a base layer adhered to the glove body 1, wherein the combing teeth 2g are evenly protruded from the base layer, as shown in FIG. 5. In particularly, the combing teeth 2g are aligned in a row manner at transverse direction. However, the alignment of the combing teeth 2g can be alternated during the fabrication. At least a row of the combing teeth 2g is misaligned with another neighboring row of the combing teeth 2g. In other words, one orthonormal matrix of tooth row is diagonally arrayed relative to another orthonormal matrix of the neighboring tooth row of the combing teeth. Tile distance between every two neighboring combing teeth 2g is the same. Preferably, each of the combing teeth 2g has a cone shape or a pillar shape, as shown in FIGS. 7 and 8. Accordingly, the height, shape and size of each of the combing teeth 2g can be alternated according to the need of the user.

The glove body 1 can have alternative embodiments. In the preferred embodiment, the glove body 1 is made of latex material. Alternatively, it is made of artificial fibers, general rubber, plastic membrane, nylon, and even cloth.

Referring to FIG. 8, the adhering layer 3 is made of benzene free adhesive which is environmental friendly. Alternatively, other adhesive can be selected.

The advantages of the present invention are: using current available technique to affix the combing teeth to the glove being worn by the user so as to reduce the production cost and enhance the practical use; the grooming unit is constructed with multiple of pieces which are linked by flexible bands to increase the flexibility of the grooming unit in responsive to the hand and finger movements of the user; the benzene-free adhering layer is strong, harmless, and environment friendly.

The above embodiments are use as the right handed gloves as examples, the invention can also be applied to left hand.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A glove, comprising:
a glove body, which is adapted for being worn by a user, having a contacting side, a palm portion and one or more finger portions;
a grooming unit comprising a palm grooming member, a finger grooming member, and a plurality of combing teeth spacedly protruded from said palm grooming member and said finger grooming member; and
an adhering layer provided at said contacting side of said glove body to adhere said grooming unit thereto, wherein said palm grooming member is affixed to said palm portion of said glove body while said finger grooming member is affixed to each of said finger portions of said glove body, such that said combing teeth are spacedly protruded from said contacting side of said glove body.

2. The glove, as recited in claim 1, wherein said finger grooming member is integrally extended from said palm grooming member to form a one-piece structure.

3. The glove, as recited in claim 1, wherein said grooming unit further comprises a plurality of first flexible bands extended from said finger grooming members to said palm grooming member in such a manner that when said glove body is worn, each of said first flexible bands is located at said glove body at a position between the proximal phalanges and the metacarpals of the user's hand for enhancing a hand movement of the user.

4. The glove, as recited in claim 1, wherein each of said finger grooming members comprises a finger head member and a finger root member spacedly affixed to said respective finger portion of said glove body.

5. The glove, as recited in claim 4, wherein each of said finger grooming members comprises a finger head member and a finger root member spacedly affixed to said respective finger portion of said glove body.

6. The glove, as recited in claim 4, wherein each of said finger grooming members further comprises a second flexible boned extended from said finger head member to said finger root member, in such a manner that when said glove body is worn, each of said second flexible bands is located at said glove body at a position between the proximal phalanges and intermediate phalanges of the user's hand for enhancing a finger movement of the user.

7. The glove, as recited in claim 5, wherein each of said finger grooming members further comprises a second flexible band extended from said finger head member to said finger root member, in such a manner that when said glove body is worn, each of said second flexible bands is located at said glove body at a position between the proximal phalanges and intermediate phalanges of the user's hand for enhancing a finger movement of the user.

8. The glove, as recited in claim 1, wherein one orthonormal matrix of tooth row is diagonally arrayed relative to another orthonormal matrix of the neighboring tooth row of said combing teeth.

9. The glove, as recited in claim 2, wherein one orthonormal matrix of tooth row is diagonally arrayed relative to another orthonormal matrix of the neighboring tooth row of said combing teeth.

10. The glove, as recited in claim 3, wherein one orthonormal matrix of tooth row is diagonally arrayed relative to another orthonormal matrix of the neighboring tooth row of said combing teeth.

11. The glove, as recited in claim 7, wherein one orthonormal matrix of tooth row is diagonally arrayed relative to another orthonormal matrix of the neighboring tooth row of said combing teeth.

12. The glove, as recited in claim 1, wherein said glove body has a thumb portion which is free of said grooming unit.

13. The glove, as recited in claim 7, wherein said glove body has a thumb portion which is free of said grooming unit.

14. The glove, as recited in claim 11, wherein said glove body has a thumb portion which is free of said grooming unit.

15. The glove, as recited in claim 7, wherein each of said combing teeth has a cone shape.

16. The glove, as recited in claim 14, wherein each of said combing teeth has a cone shape.

17. The glove, as recited in claim 7, wherein each of said combing teeth has a pillar shape.

18. The glove, as recited in claim 14, wherein each of said combing teeth has a pillar shape.

19. The glove, as recited in claim 16, wherein said adhering layer is made of benzene-free material.

20. The glove, as recited in claim 18, wherein said adhering layer is made of benzene-free material.
